(19) United States
(12) Patent Application Publication
(10) Pub. No.: US 2024/0109621 A1
(43) Pub. Date: Apr. 4, 2024

(54) MOTOR FOR A BICYCLE, AND BICYCLE

(71) Applicant: Silent Leader GmbH, Gauting (DE)

(72) Inventor: Theodor Piele, Gauting (DE)

(21) Appl. No.: 18/534,712

(22) Filed: Dec. 10, 2023

Related U.S. Application Data
(63) Continuation of application No. PCT/EP2021/075751, filed on Oct. 18, 2021.

(30) Foreign Application Priority Data
Jun. 10, 2021 (DE) 10 2021 002 975.5

(51) Int. Cl. B62M 6/65; B62J 45/411

(52) U.S. Cl. CPC B62M 6/65; B62J 45/411

(57) ABSTRACT

A motor for a bicycle includes a wheel axle, a hub housing, a bearing seat, and two through-holes, arranged in a housing cover next to each other in the circumferential direction with respect to the wheel axle, a driver configured to receive a torque applied by the operator of the bicycle by peddling and a driver through-hole, through which the wheel axle extends outside of the hub housing, a respective pin for each through-hole, said pin extending through one of the through-holes, a measuring disc arranged in the interior and outside of the bearing seat in a radial direction with respect to the wheel axle, a measuring disc through-hole, through which the wheel axle extends, and configured to receive the torque from the pins and transmit a torque to the hub housing, and a torque measuring device configured to determine the torque based on a deformation of the measuring disc.

### CROSS REFERENCE TO RELATED APPLICATIONS

This application is a continuation application of international patent application PCT/EP2021/075751 filed on Oct. 18, 2021, designating the United States, and claiming priority to German application 10 2021 022 975.5, filed Jun. 10, 2021, and the entire content of these applications is incorporated herein by reference and the entire content of this application is incorporated herein by reference.

### TECHNICAL FIELD

The disclosure relates to a motor for a bicycle, and to the bicycle having the motor.

### BACKGROUND

A motor for a bicycle can be disposed in a region of a rear running wheel of the bicycle, for example. The output to be delivered for propulsion of the bicycle by the motor can be controlled, for example, as a function of a torque which is applied by a rider of the bicycle when pedaling.

### SUMMARY

It is therefore an object of the disclosure to achieve a motor for a bicycle, and the bicycle having the motor, wherein a torque applied by a rider of the bicycle can be measured by the motor.

The motor according to an aspect of the disclosure for a bicycle has a wheel axle which is provided to be fastened to a frame of the bicycle, a hub housing that has a housing cover delimiting an interior space of the motor in an axial direction in terms of the wheel axle, and a housing cover through-bore through which the wheel axle extends, a bearing seat that projects in the axial direction from the remaining housing cover, and has at least two through-bores which are disposed in the housing cover so as to be beside one another in a circumferential direction in terms of the wheel axle, a driver which is specified to receive a torque applied by a rider of the bicycle by pedaling, and a driver through-bore through which the wheel axle extends outside the hub housing and which has in each case one pin extending through one of the through bores for each of the through-bores, a measuring disk which is disposed in the interior space and outside the bearing seat in a radial direction in terms of the wheel axle, and which has a measuring disk through-bore through which the wheel axle extends and is specified to receive the torque form the pins and to transmit the torque to the hub housing, and a torque measuring device which is specified to determine the torque based on a deformation of the measuring disk.

When riding the bicycle, a torque is applied by a rider as a result of his/her pedaling. The torque is transmitted to a driver which by way of the pins transmits the torque to the measuring disk via the through-bores. The torque is transmitted from the measuring disk to the hub housing. The deformation of the measuring disk takes place in the process, wherein the deformation is determined by the torque measuring device. The torque measuring device is specified to draw a conclusion pertaining to the torque based on the size of the deformation. In this way, a motor is achieved which is specified to measure the torque applied by the rider. The housing cover herein is specified to allow, with the through-bores, the torque to pass from outside the hub housing into the interior space, and it is simultaneously possible to mount, with the bearing seat, the housing cover and thus the hub housing so as to be rotatable in relation to the wheel axle.

The motor typically has a first radial bearing which supports the bearing seat inside in the radial direction and mounts the housing cover so as to be rotatable in relation to the wheel axle. To this end, the bearing seat can have, for example, a bearing face which is directed inward in the radial direction and in particular has the shape of a cylindrical shell. It is conceivable herein for example that the bearing face is in contact with rolling members, for example balls, of the first radial bearing. Alternatively, it is conceivable for example that a housing shell of the first radial bearing is fastened to the bearing face.

It is typical that the torque measuring device has a strain gauge which is attached to the measuring disk. To this end, the measuring disk can have one or a plurality of sliding contacts by way of which a resistance of the strain gauge can be read.

It is typical that the measuring disk is magnetic, and the torque measuring device has a sensor which is specified to measure the deformation of the measuring disk using magnetostriction. It can be exploited herein that the magnetic properties of the measuring disk vary as a function of the size of the deformation of the measuring disk. It is particularly typical herein that the wheel axle has a wheel axle disk which projects outward in the radial direction from the remaining wheel axle and to which the sensor is attached. The sensor can have, for example, one coil or a plurality of coils.

The pins typically project outward in the radial direction from the remaining driver.

It is typical that the bearing seat has a plurality of axial webs which project in the axial direction from the remaining housing cover, wherein each of the through-bores is delimited in the circumferential direction by in each case two of the axial webs. It is particularly typical herein that the bearing seat has an annular body which is fastened to the longitudinal ends of the axial webs that lie in the axial direction and has the bearing face which faces inward in the radial direction, wherein the annular body delimits each of the through-bores in the axial direction. It is moreover particularly typical that the housing cover for each of the axial webs has in each case one radial web which is fastened to a surface of the housing cover that faces inward in the radial direction, projects inward in the radial direction from the remaining housing cover and to which in each case one of the axial webs is fastened.

The motor typically has a freewheel which has a first freewheel half and a second freewheel half that is formed by the driver. It is advantageously achieved as a result that the deformation of the measuring disk occurs only when the torque is actually transmitted to the hub housing. In contrast, if the second freewheel half overruns the first freewheel half, no torque is transmitted to the second freewheel half and thus also no torque is transmitted to the hub housing, as a result of which there is also no deformation of the measuring disk. It is particularly typical herein that the motor has a sprocket carrier which is coupled in a rotationally rigid manner to the first freewheel half.

The pins are typically engaged with the measuring disk. Alternatively, it is typical that the motor has an intermediate ring which on the side thereof that faces inward in the radial direction is engaged with the pins and on the side thereof that faces outward in the radial direction has an external-tooth gear ring which is engaged with an internal-tooth gear ring of the measuring disk that is disposed on that side of the measuring disk that faces inward in the radial direction. By providing the intermediate ring, the torque that is transmitted from the driver to the measuring disk can be distributed more uniformly along the circumferential direction than without the intermediate ring.

It is typical that the pin has a plurality of teeth. It is particularly typical herein that the measuring disk or the intermediate ring has a respective clearance for each tooth. By providing the teeth, the torque that is transmitted from the driver to the measuring disk can be distributed more uniformly along the circumferential direction than without the teeth.

It is typical that the measuring disk on the measuring disk through-bore has a measuring disk protrusion which projects in the axial direction and which delimits the measuring disk through-bore in the circumferential direction along the entire circumference. For example, by providing the measuring disk protrusion, an axial extent of the measuring disk in the axial direction in a region of the measuring disk protrusion can be at least twice the length, or at least three times the length, as in a region of the measuring disk that is contiguous to the measuring disk protrusion.

It is furthermore typical that the driver engages in the measuring disk along the entire extent of the measuring disk through-bore in the axial direction. Alternatively, it is typical that the driver engages in the measuring disk only in an axial region of the measuring disk protrusion that extends in the axial direction. It is achieved in particular with the alternatively exemplary embodiments that a force flux between the driver and the periphery of the measuring disk lying outside in the radial direction has an axial component in the measuring disk protrusion. It is achieved as a result that the mechanic stress in the measuring disk is distributed more homogenously. The axial region can be spaced apart from a part of the measuring disk, wherein the part is contiguous to the measuring disk protrusion. For example, the axial region can be at most one third of the extent of the measuring disk through-bore in the axial direction.

It is typical that, for transmitting the torque from the measuring disk to the hub housing, the measuring disk is fastened to the hub housing, in particular to the housing cover, in a form-fitting and/or force-fitting manner. For the form-fit, the measuring disk can have, for example, a measuring disk pin which engages in a housing clearance of the hub housing, in particular of the housing cover. Alternatively, it is conceivable that, for the form-fit, the hub housing, in particular the housing cover, has a housing pin which engages in a measuring disk clearance of the measuring disk. An interference fit is conceivable for the force-fit, for example.

It is typical that the measuring disk has an external toothing, and the hub housing has an internal toothing, wherein the external toothing is engaged with the internal toothing, wherein the internal toothing is formed in particular by the housing cover. The measuring disk can be fastened to the hub housing in a form-fitting and/or force fitting manner with the external toothing and the internal toothing.

Provided typically in the circumferential direction between the pin and the housing cover is a spacing which is greater than zero when the torque equals zero, and becomes smaller when the torque becomes greater than zero, wherein the pin impacts on the housing cover when the torque becomes greater than a limit torque, in particular wherein the limit torque is chosen in such a way that the latter occurs when pedaling. It is advantageously achieved as a result that, when the torque is greater than the limit torque, not the entire torque is transmitted to the hub housing by way of the measuring disk, but that part of the torque is transmitted directly from the driver to the hub housing. As a result, intense stress on the measuring disk can be precluded.

The motor is typically an electric motor.

The bicycle according to an aspect of the disclosure has the motor. It is typical herein that the motor is disposed in a rear running wheel of the bicycle.

### BRIEF DESCRIPTION OF THE DRAWINGS

The disclosure will now be described with reference to the drawings wherein:

FIG. 1 shows an exploded drawing of the motor 1,

FIG. 2 shows a first longitudinal section through the motor 1, wherein the longitudinal section runs between two pins 18,

FIG. 3 shows a second longitudinal section through the motor 1, wherein the longitudinal section runs through one of the pins 18,

FIG. 4 shows a first perspective view of a housing cover 9 of the motor 1,

FIG. 5 shows a second perspective view of the housing cover,

FIG. 6 shows a first perspective view of a driver 32 of the motor 1,

FIG. 7 shows a second perspective view of the driver 32,

FIG. 8 shows a perspective view of a measuring disk 20 of the motor 1,

FIG. 9 shows a perspective view of the housing cover 9 and of the measuring disk 20, which are assembled, and

FIG. 10 shows a perspective view of the housing cover 9 and of the driver 32, which are assembled.

### DESCRIPTION OF EXEMPLARY EMBODIMENTS

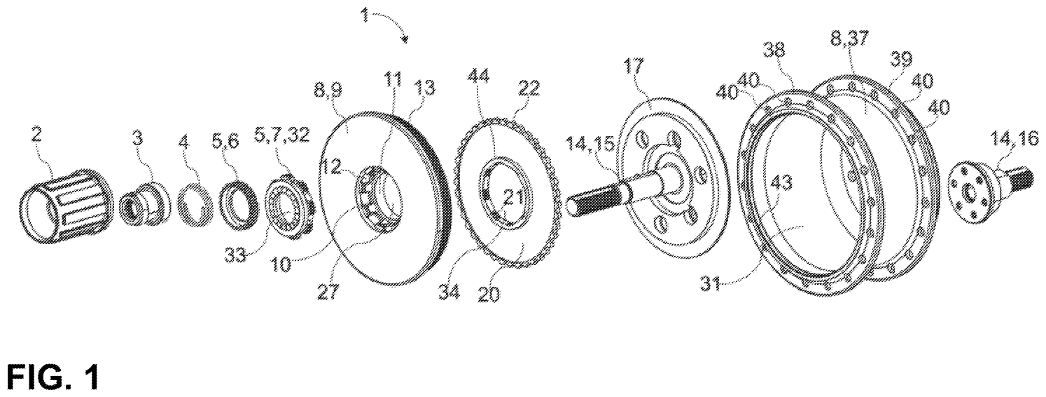

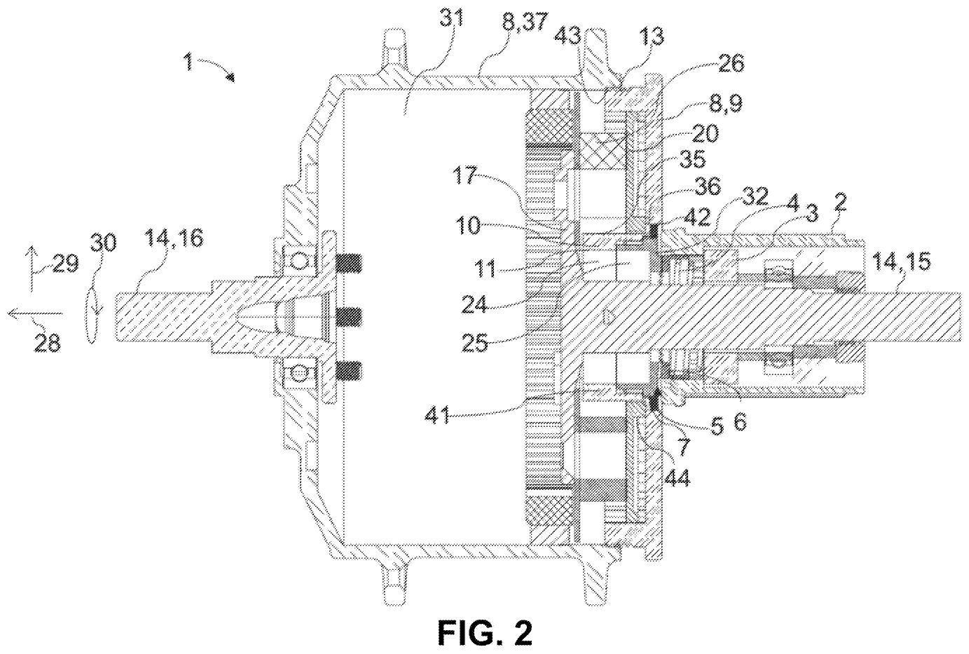

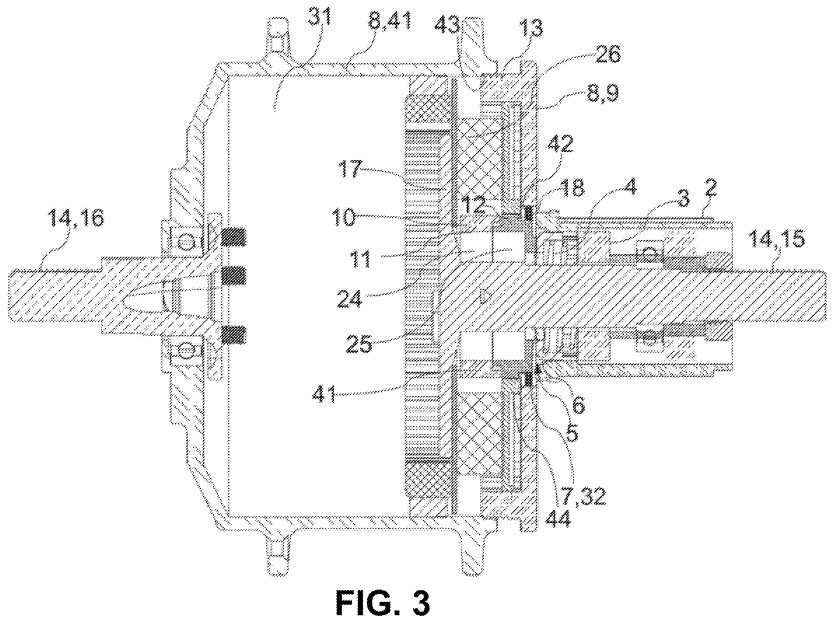

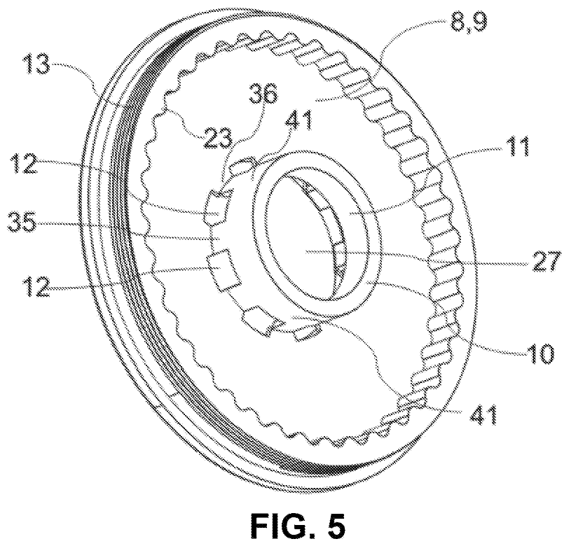

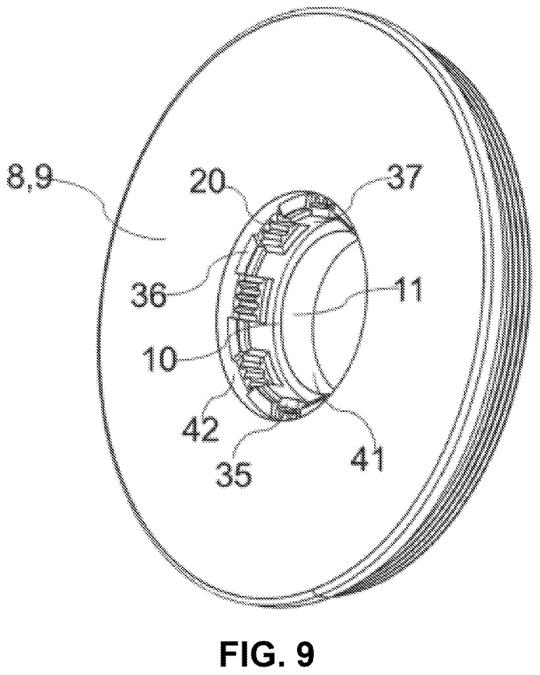

As can be seen from FIGS. 1 to 10, a motor 1 for a bicycle has a wheel axle 14, a hub housing 8, a driver 32, a measuring disk 20, and a torque measuring device. The wheel axle 14 is provided to be fastened to a frame of the bicycle. The hub housing 8 has a housing cover 9 which delimits an interior space 31 of the motor 1 in an axial direction 28 in terms of the wheel axle 14, and a housing cover through-bore 27 through which the wheel axle 14 extends, a bearing seat 10 that projects in the axial direction 28 from the remaining housing cover 9 and has at least two through-bores 12 which are disposed in the housing cover 9 beside one another in a circumferential direction 30 in terms of the wheel axle 14. It can be seen in particular from FIGS. 2 and 3 that the bearing seat 10 can protrude into the interior space 31. The driver 32 is specified to receive a torque applied by a rider of the bicycle by pedaling. Moreover, the driver 32 has a driver through-bore 33 through which the wheel axle 14 extends outside the hub housing 8, and in each case one pin 18, which extends through one of the through-bores 12, for each of the through-bores 12. The measuring disk 20 is disposed in the interior space 31 and outside the bearing seat 10 in a radial direction 29 in terms of the wheel axle 14. Moreover, the measuring disk 20 has a measuring disk through-bore 34 through which the wheel axle 14 extends and is specified to receive the torque from the pins 18 and to transmit the torque to the hub housing 8. The torque measuring device is specified to determine the torque based on a deformation of the measuring disk 20.

The motor 1 can be, for example, an electric motor. The motor 1 can be disposed in a rear running wheel of a bicycle, for example.

The bearing seat 10 can have a plurality of axial webs 35 (cf. FIGS. 2, 4, 5, 9, and 10) which project from the remaining housing cover 9 in the axial direction 28, wherein each of the through-bores 12 is delimited by in each case two of the axial webs 35 in the circumferential direction 30. Moreover, the bearing seat 10 can have an annular body 41 (see in particular FIGS. 2 to 5, 9 and 10) which is fastened to the longitudinal ends of the axial webs 35 that lie in the axial direction 28 and protrude into the interior space 31 and has a bearing face 11 that faces inward in the radial direction 29, wherein the annular body 41 delimits each of the through-bores 12 in the axial direction 28. The bearing face 11 can have the shape of a cylindrical shell, for example (see in particular FIGS. 2, 3, 5, and 19). FIGS. 2 and 3 show that the motor 1 can have a first radial bearing 24 which supports the bearing seat 10 inside in the radial direction 29 and mounts the housing cover 9 so as to be rotatable in relation to the wheel axle 14. To this end, the bearing face 11 can be in contact with rolling members, for example balls, of the first radial bearing 24. Alternatively, a housing shell of the first radial bearing 24 can be fastened to the bearing face 11.

The figures show that more than two of the through-bores 12 can also be provided; in particular, from four to twelve of the through-bores 12, or eight of the through-bores 12, can be provided, for example. A high strength of the bearing seat 10 is guaranteed as a result, and the torque is simultaneously directed into the measuring disk 20 very uniformly along the circumferential direction 30. The through-bores 12 can be distributed uniformly in the circumferential direction 30.

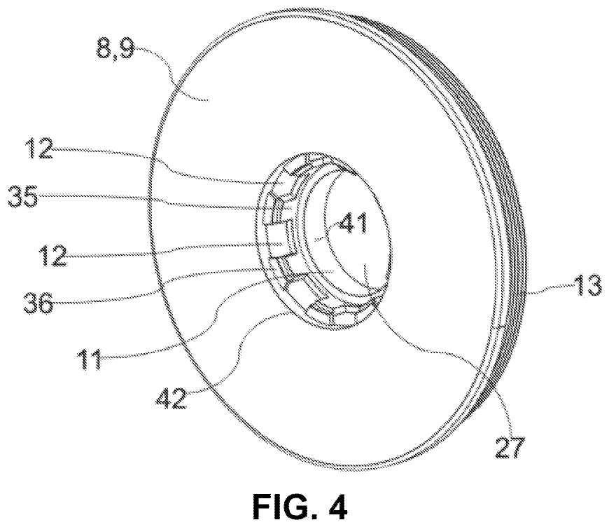

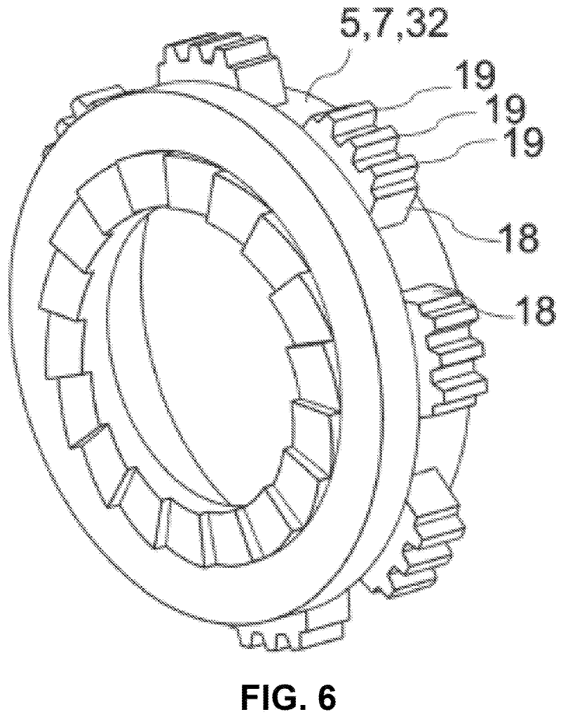

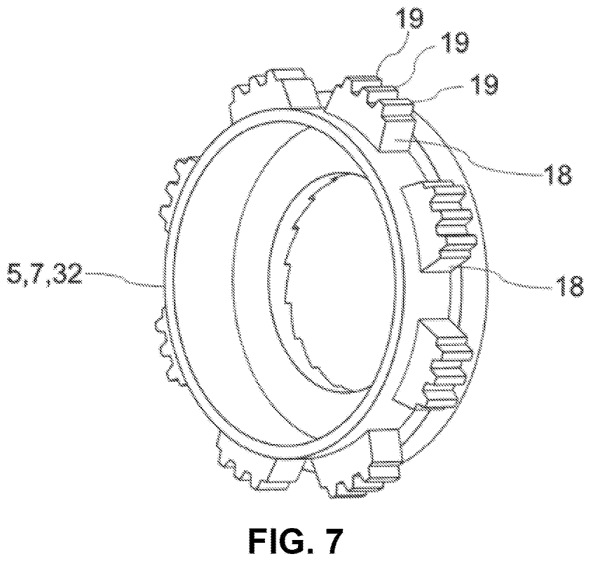

It can be seen from FIGS. 2, 4, 5, 9, and 10 that the housing cover 9 for each of the axial webs 35 can have in each case one radial web 36 which is fastened to a surface 42 of the housing cover 9 that faces inward in the radial direction 29, projects inward in the radial direction 29 from the remaining housing cover 9 and to which in each case one of the axial webs 36 is fastened. The inwardly facing surface 42 can delimit the housing cover through-bore 27, for example, see in particular FIG. 4. By providing the radial webs 36, the axial webs 35, when viewed in the axial direction 28, are disposed within the inwardly facing surface 42 (see FIGS. 2 and 4, for example). Moreover, an external diameter of the driver 32 can be embodied to be shorter than an external diameter of the housing cover through-bore 27. As a result, and by providing the radial webs 36, it is possible for the driver 32 to be displaced in the axial direction 28 in the direction toward the housing cover 9, for assembling the motor 1, such that the pins 18 make their way into the through-bores 12. The pins 18 herein can project outward in the radial direction 29 from the remaining driver 32, for example, cf. in particular FIGS. 6 and 7. The external diameter of the driver 32 herein can be twice the spacing of an outer end of one of the pins from the center of the driver 32. The external diameter of the housing cover through-bore 27 herein can be twice the spacing of the inwardly facing surface 42 from the center of the housing cover through-bore 27. FIGS. 1 and 2 show that the measuring disk 20 can be disposed completely outside the bearing seat 10.

The measuring disk 20 can be magnetic, and the torque measuring device can have a sensor 26 (see FIGS. 2 and 3) which is specified to measure the deformation of the measuring disk 20 using magnetostriction. The wheel axle 14 herein can have a wheel axle disk 17 which is disposed in the interior space 31, projects outward in the radial direction 29 from the remaining wheel axle 14 and to which the sensor 26 is attached. As an alternative to the magnetic embodiment of the measuring disk 20, the torque measuring device can have a strain gauge which is applied to the measuring disk 20. The motor 1 herein can have a slider which is applied to the measuring disk 20, and an electrical contact which is in contact with the slider and by way of which a resistance of the strain gauge can be read, can be attached to the wheel axle disk 17 instead of the sensor 26.

The wheel axle 14 can have a first wheel sub-axle 15 and a second wheel sub-axle 16, which are disposed so as to be spaced apart from one another in the axial direction 28. The wheel axle disk 17 can form that end of the first wheel sub-axle 16 that lies in the interior space 31, cf. FIGS. 1 and 2, for example.

The pins 18 can be engaged with the measuring disk 20. In particular, the pins 18 can be engaged with the measuring disk 20 in a form-fitting and/or force-fitting manner. Alternatively, it is conceivable that the motor 1 has an intermediate ring (not illustrated in the figures) which on the side thereof that faces inward in the radial direction 29 is engaged with the pins 18 and on the side thereof that faces outward in the radial direction 29 has an external-tooth gear ring which is engaged with an internal-tooth gear ring of the measuring disk 20 that is disposed on that side of the measuring disk 20 that faces inward in the radial direction 29.

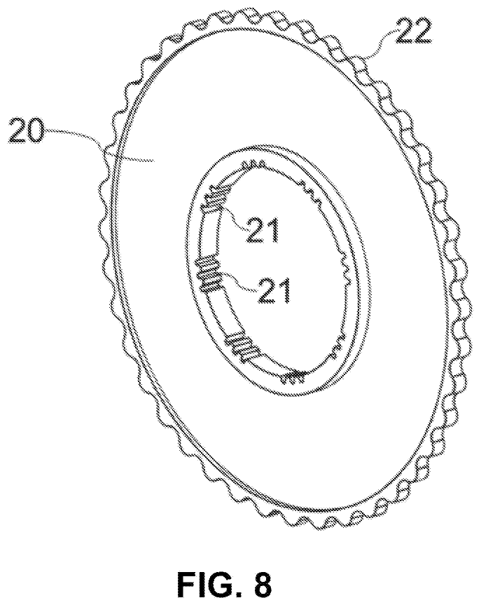

It can be seen in particular from FIGS. 6 and 7 that each of the pins 18 can have a plurality of teeth 19. The measuring disk 20 herein can have in each case one clearance 21 for each of the teeth 19 (see in particular FIG. 8), in which in each case one of the teeth 19 engages. In the case of the intermediate ring being provided, the intermediate ring can have in each case one clearance for each of the teeth 19, in which in each case one of the teeth 19 engages.

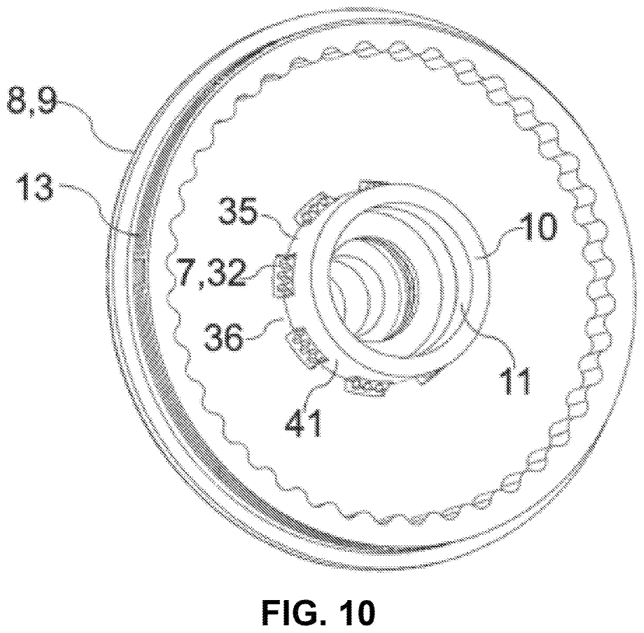

The measuring disk 20 can have an external toothing 22 (cf. FIG. 8), and the hub housing 8 can have an internal toothing 23 (cf. FIG. 10), wherein the external toothing 22 is engaged with the internal toothing 23. FIG. 10 shows that the internal toothing 23 can be formed by the housing cover 9. The measuring disk 20 can be fastened to the hub housing 8, in particular to the housing cover 9, in a form-fitting and/or force-fitting manner. An interference fit is conceivable for the force-fit, for example.

In addition to the measuring disk through-bore 34, the measuring disk 20 can also have one bore, a plurality of bores, one slot or a plurality of slots. Moreover, it is conceivable that the measuring disk 20 has one web, a plurality of webs, one elevation and/or a plurality of elevations.

A maximum extent of the measuring disk 20 in the radial direction 29 can be longer than a maximum extent of the measuring disk 20 in the axial direction 28.

FIGS. 1 to 3 show that the measuring disk 20 on the measuring disk through-bore 34 can have a measuring disk protrusion 44 which projects in the axial direction 28 and delimits the measuring disk through-bore 34 in the circumferential direction 30 along the entire circumference. For example, by providing the measuring disk protrusion 44, an axial extent 28 of the measuring disk 20 in the axial direction 28 in a region of the measuring disk protrusion 44 can be at least twice the length, or at least three times the length, as in a region of the measuring disk 20 that is contiguous to the measuring disk protrusion 44.

The driver 32 can engage in the measuring disk 20 along the entire extent of the measuring disk through-bore 34 in the axial direction 28, or the driver 32 can engage in the measuring disk 20 along an extent of the measuring disk through-bore 34 in the axial direction 28, wherein the extent is at least 80% or 90% of the entire extent, see FIG. 3. Alternatively, it is conceivable that the driver 32 engages in the measuring disk 20 only in an axial region of the measuring disk protrusion 44 that extends in the axial direction 28. It is achieved in particular by the alternatively exemplary embodiments that a force flux between the driver 32 and that periphery of the measuring disk 20 that lies outside in the radial direction 29 has an axial component in the measuring disk protrusion 44. A more homogeneous distribution of the mechanical stress in the measuring disk 20 is achieved as a result. The axial region can be spaced apart from a part of the measuring disk 20, wherein the part is contiguous to the measuring disk protrusion 44. The axial region can be at most one third of the extent of the measuring disk through-bore 34 in the axial direction 28, for example.

FIGS. 1 to 3 show that the motor 1 can have a freewheel 5 which has a first freewheel half 6 and a second freewheel half 7 that is formed by the driver 32. The first freewheel half 6 and the second freewheel half 7 can be coupled axially to one another. To this end, the first freewheel half 6 and the second freewheel half 7 can in each case have a toothing which projects in the axial direction 28 from the respective remaining freewheel half 6, 7, and the two toothings can be engaged with one another. The motor 1 can have a sprocket carrier 2 which is coupled in a rotationally rigid manner to the first freewheel half 6. Moreover, the motor 1 can have a second radial bearing 3 which supports the sprocket carrier 2 inside in the radial direction 29, and mounts the sprocket carrier 2 so as to be rotatable in relation to the wheel axle 14. Moreover, the motor 1 can have a compression spring 4 which preloads the first freewheel half 6 in the direction toward the second freewheel half 7. To this end, the compression spring 4 can be supported on the second radial bearing 3. Moreover, a third radial bearing 25, which supports the second freewheel half 7 inside in the radial direction 29 and mounts the second freewheel half 7 so as to be rotatable in relation to the wheel axle 14, can be provided.

It can be seen in particular from FIG. 10 that provided in the circumferential direction 30 between the pin 18 and the housing cover 9 is a spacing which is greater than zero when the torque equals zero, and becomes smaller when the torque becomes greater than zero, wherein the pin 18 impacts on the housing cover 9 when the torque becomes greater than a limit torque, in particular wherein the limit torque is chosen in such a way that the latter occurs when pedaling. The limit torque may be at least 100 Nm, or at least 200 Nm, for example. The limit torque may be at most 300 Nm or at most 350 Nm, for example. The spacing can in particular be configured between the pin 18 and the axial web 35. As a result, the pin 18 impacts on the axial web 35 when the torque becomes greater than the limit torque.

FIGS. 1 to 3 show that the hub housing 8 can have a housing ring 37 which delimits the interior space 31 in the radial direction 29. The housing ring 37 can have an internal thread 43, and the housing cover 9 can have an external thread 13, said threads being screwed to one another. The housing ring 37 can have a first annular protrusion 38 and a second annular protrusion 39, said protrusions each having a plurality of attachment bores 43 into which spokes of a running wheel of the bicycle can be hooked.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

1 Motor
2 Sprocket carrier
3 Second radial bearing
4 Compression spring
5 Freewheel
6 First freewheel half
7 Second freewheel half
8 Hub housing
9 Housing cover
10 Bearing seat
11 Bearing face
12 Through-bore
13 External thread
14 Wheel axle
15 First wheel sub-axle
16 Second wheel sub-axle
17 Wheel axle disk
18 Pin
19 Tooth
20 Measuring disk
21 Clearance
22 External toothing
23 Internal toothing
24 First radial bearing
25 Third radial bearing
26 Sensor
27 Housing cover through-bore
28 Axial direction
29 Radial direction
30 Circumferential direction
31 Interior space
32 Driver
33 Driver through-bore
34 Measuring disk through-bore
35 Axial web
36 Radial web
37 Housing ring
38 First annular protrusion
39 Second annular protrusion
40 Attachment bores
41 Annular body
42 Surface facing inward in the radial direction
43 Internal thread
44 Measuring disk protrusion

What is claimed is:

1. A motor for a bicycle, the motor comprising:
a wheel axle provided to be fastened to a frame of the bicycle;
a hub housing which has a housing cover delimiting an interior space of the motor in an axial direction in terms of the wheel axle and a housing cover through-bore through which the wheel axle extends;
a bearing seat which projects in the axial direction from the remaining housing cover and has at least two through-bores which are disposed in the housing cover beside one another in a circumferential direction in terms of the wheel axle;
a driver configured to receive a torque applied by a rider of the bicycle by pedaling;
a driver through-bore through which the wheel axle extends outside the hub housing and which has in each case one pin, extending through one of the through-bores, for each of the through-bores, a measuring disk which is disposed in the interior space and outside the bearing seat in a radial direction in terms of the wheel axle, and which has a measuring disk through-bore through which the wheel axle extends and is configured to receive the torque from the pins and to transmit the torque to the hub housing; and
a torque measuring device configured to determine the torque based on a deformation of the measuring disk.

2. The motor as claimed in claim 1, further comprising:
a first radial bearing which supports the bearing seat inside in the radial direction and mounts the housing cover so as to be rotatable in relation to the wheel axle.

3. The motor as claimed in claim 1, wherein the torque measuring device has a strain gauge which is attached to the measuring disk.

4. The motor as claimed in one of claim 1, wherein the measuring disk is magnetic, and the torque measuring device has a sensor which is configured to measure the deformation of the measuring disk with magnetostriction.

5. The motor as claimed in claim 4, wherein the wheel axle has a wheel axle disk which projects outward in the radial direction from the remaining wheel axle and to which the sensor is attached.

6. The motor as claimed in claim 1, wherein the bearing seat has a plurality of axial webs which project in the axial direction from the remaining housing cover, and
wherein each of the through-bores is delimited in the circumferential direction by in each case two of the axial webs.

7. The motor as claimed in claim 6, wherein the bearing seat has an annular body fastened to the longitudinal ends of the axial webs which lie in the axial direction and a bearing face which faces inward in the radial direction, and
wherein the annular body delimits each of the through-bores in the axial direction.

8. The motor as claimed in claim 6, wherein the housing cover for each of the axial webs has in each case one radial web which is fastened to a surface of the housing cover which faces inward in the radial direction, projects inward in the radial direction from the remaining housing cover and to which in each case one of the axial webs is fastened.

9. The motor as claimed in claim 1, further comprising:
a freewheel which has a first freewheel half and a second freewheel half which is formed by the driver.

10. The motor as claimed in claim 9, further comprising:
a sprocket carrier coupled in a rotationally rigid manner to the first freewheel half.

11. The motor as claimed in one of claim 1, wherein the pins are engaged with the measuring disk.

12. The motor as claimed in claim 1, further comprising:
an intermediate ring which on the side thereof that faces inward in the radial direction is engaged with the pins and on the side thereof that faces outward in the radial direction has an external-tooth gear ring which is engaged with an internal tooth gear ring of the measuring disk which is disposed on the side of the measuring disk which faces inward in the radial direction.

13. The motor as claimed in claim 1, wherein the measuring disk has an external toothing, and the hub housing has an internal toothing,
wherein the external toothing is engaged with the internal toothing, and
wherein the internal toothing is formed by the housing cover.

14. The motor as claimed in claim 1, wherein provided in the circumferential direction between the pin and the housing cover is a spacing which is larger than zero when the torque equals zero, and becomes smaller when the torque becomes larger than zero,
wherein the pin impacts on the housing cover when the torque becomes larger than a limit torque, and
wherein the limit torque is chosen such that the limit torque occurs when pedaling.

15. A bicycle including the motor as claimed in claim 1, wherein the motor is disposed in a rear running wheel of the bicycle of receiving stations.
